(19) United States
(12) Patent Application Publication
(10) Pub. No.: US 2007/0214057 A1
(43) Pub. Date: Sep. 13, 2007

(54) Sales event with real-time pricing

(75) Inventors: Hao Lee, Los Gatos, CA (US); Yong Xiao, Union City, CA (US); Michael Jianzhong Xue, Natick, MA (US); David Wanqian Liu, South San Francisco, CA (US)

Correspondence Address: BEYER WEAVER LLP, P.O. BOX 70250, OAKLAND, CA, 94612-0250, US

(73) Assignee: Oprices, Inc.

(21) Appl. No.: 11/497,661

(22) Filed: Aug. 1, 2006

Related U.S. Application Data
(60) Provisional application No. 60/781,435, filed on Mar. 11, 2006.

(51) Int. Cl. G06Q 30/00

(52) U.S. Cl. 705/26

(57) ABSTRACT

Disclosed are apparatus, methods, systems, and computer program products for providing pricing options for a sales event of online shopping over a data network. In one embodiment, an item selection signal is received over the data network from a data processing device associated with a customer. The item selection signal indicates an item selected for purchase. Responsive to receiving the item selection signal, a plurality of pricing options is retrieved for the selected item. A graphical representation of the plurality of pricing options is generated for display on the data processing device associated with the customer. A pricing option selection signal is received over the data network from the data processing device associated with the customer. The pricing option selection signal indicates a selected one of the plurality of pricing options. A pricing outcome is retrieved from an outcome determination module. The pricing outcome determines a sale price according to a price and a probability of the selected one pricing option. The sale price is provided over the data network to the data processing device associated with the customer for purchase of the selected item.

### REFERENCE TO EARLIER-FILED APPLICATION

The present application claims priority to co-pending U.S. Provisional Patent Application No. 60/781,435, filed Mar. 11, 2006, for SALES EVENT WITH REAL-TIME PRICING, Attorney Docket No. OPRIP001P, which is incorporated herein by reference in its entirety for all purposes.

### FIELD

The present invention relates to online shopping. More particularly, the present invention relates to the pricing of items for sale in an online shopping experience.

### BACKGROUND

With the increased popularity of the Internet, online shopping has become a popular alternative to conventional shopping at brick and mortar stores. Online shopping generally refers to the offer for sale, browsing, and purchase of items over data networks such as the Internet. In one example, an item for sale is advertised on a web page on behalf of a seller. An online shopper navigates the Internet using a web browser to identify the advertisement. The shopper can select the advertised item for purchase, often by clicking on an electronic representation of the item to add the item to an electronic shopping cart. After adding one or more items to the shopping cart, the shopper can check out, that is, complete an online purchase of the items in the cart often by entering credit card information and a delivery address. The seller of the items then charges the shopper's credit card and delivers the purchased items.

FIG. 1 shows a conventional method 100 of online shopping, performed by a customer. The method 100 can involve iterative cycles of product comparison from vendor to vendor before a final decision of purchase. Thus, the various steps 105-125 described herein can occur in any order, and be repeated as desired. One iteration begins in step 105 in which an online shopper, also referred to herein as a customer, researches a product for possible purchase. The shopper may become aware of the particular product by seeing it advertised on a website of Store 1, Store 2, Store 3, or another source.

In FIG. 1, various models and brands of the same product are often available. In step 110, the shopper decides which model and brand to purchase, based on the information gathered in step 105. In step 115, the shopper determines the price of the chosen model and brand, and checks if the price is within the shopper's budget, in step 120. In step 125, the shopper identifies Stores 1 and 2, and possibly additional online merchants, that carry the desired product. After performing iterations of the various steps 105-125 as desired, the shopper then chooses one of the identified stores from which to buy the product, in step 130. Often, the buying step 130 is based on the selected merchant's price for the product, as well as other criteria such as merchant reputation, warranties, and service.

The wealth of information available on the Internet benefits shoppers, including those who perform the shopping method 100 of FIG. 1. Online shoppers have grown savvier by taking advantage of information available online, including product brands, specifications, quality rankings, and pricing. In particular, the transparency of product and pricing information has greatly benefited online shoppers in getting the best deals. Online shoppers have the convenience of immediate product research and purchase from any number of vendors at any time and any place.

For online vendors, however, pricing transparency has posed a new challenge. Customer pricing knowledge reduces the effectiveness of a sales promotion, and creates difficulty in persuading shoppers to buy at a vendor's store. With knowledge of lowest historical prices, customers are unlikely to buy a product at higher prices. Customers would rather wait for a better sales promotion to happen, resulting in small sales volume and/or insignificant profit margin for online vendors.

What is needed is a technique for an online vendor to increase overall shopper interest for items offered by that vendor, and to boost online sales volume without sacrificing total profit margin.

### SUMMARY

Aspects of the present invention relate to apparatus, methods, systems, and computer program products for providing pricing options for a sales event of online shopping over a data network.

In one aspect of the present invention, an item selection signal is received over the data network from a data processing device associated with a customer. The item selection signal indicates an item selected for purchase. Responsive to receiving the item selection signal, a plurality of pricing options is retrieved for the selected item. A graphical representation of the plurality of pricing options is generated for display on the data processing device associated with the customer. A pricing option selection signal is received over the data network from the data processing device associated with the customer. The pricing option selection signal indicates a selected one of the plurality of pricing options. A pricing outcome is retrieved from an outcome determination module. The pricing outcome determines a sale price according to a price and a probability of the selected one pricing option. The sale price is provided over the data network to the data processing device associated with the customer for purchase of the selected item.

In another aspect of the present invention, a checkout signal is received over the data network from a data processing device associated with a customer. The checkout signal indicates completion of selection of one or more items for purchase. The one or more items have a total cost. Responsive to receiving the checkout signal, a plurality of pricing options is retrieved for the total cost. A graphical representation of the plurality of pricing options is generated for display on the data processing device associated with the customer. A pricing option selection signal is received over the data network from the data processing device associated with the customer. The pricing option selection signal indicates a selected one of the plurality of pricing options. A pricing outcome is retrieved from an outcome determination module. The pricing outcome determines a sale price according to a price and a probability of the selected one pricing option. The sale price is provided over the data network to the data processing device associated with the customer for purchase of the selected one or more items.

In another aspect of the present invention, as a variation to the aspects described above, a first pricing option selection signal is received over the data network from the data processing device associated with the customer. The first pricing option selection signal indicates a first one of the plurality of pricing options. A second pricing option selection signal is received over the data network from the data processing device associated with the customer. The second pricing option selection signal indicates a second one of the plurality of pricing options. A first pricing outcome is retrieved from an outcome determination module. The first pricing outcome determines a first sale price according to the first pricing option. A second pricing outcome is retrieved from the outcome determination module. The second pricing outcome determines a second sale price according to the second pricing option. A lower one of the first sale price and the second sale price is determined. The lower one of the first and second sale prices is provided over the data network to the data processing device associated with the customer for purchase of the selected item.

In yet another aspect of the present invention, a data processing apparatus includes an interface in communication with the data network. The interface is coupled to receive a checkout signal over the data network from a data processing device associated with a customer. The checkout signal indicates completion of selection of one or more items for purchase. The one or more items have a total cost. The data processing apparatus includes a memory, which stores instructions, and a processor in communication with the interface and the memory. The processor is operable to receive the checkout signal from the interface, load the instructions from the memory responsive to receiving the checkout signal, and execute the instructions to:

a) retrieve a plurality of pricing options for the total cost,

b) generate a graphical representation of the plurality of pricing options for display on the data processing device associated with the customer,

c) receive a pricing option selection signal, the pricing option selection signal indicating a selected one of the plurality of pricing options,

d) retrieve a pricing outcome from an outcome determination module, the pricing outcome determining a sale price according to a price and a probability of the selected one pricing option, and

e) output the sale price.

### BRIEF DESCRIPTION OF THE FIGURES

The invention may best be understood by reference to the following description taken in conjunction with the accompanying drawings, which are illustrative of specific embodiments of the present invention.

FIG. 1 shows a diagram of a conventional method for online shopping, performed by a customer over a data network such as the Internet.

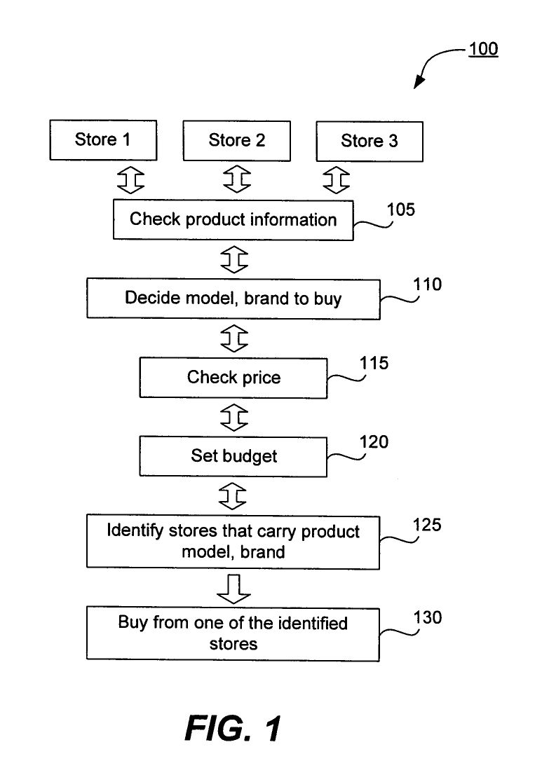

FIG. 2 shows a block diagram of a system for providing a sales event with real-time pricing, constructed according to one embodiment of the present invention.

FIG. 3 shows a flow diagram of a method for providing pricing options for a sales event of online shopping over a data network, performed according to one embodiment of the present invention.

FIG. 4 is a diagram illustrating graphical representations of a plurality of pricing options, provided according to embodiments of the present invention.

FIG. 5 shows a flow diagram of a method for providing a pricing option, performed according to one embodiment of the present invention.

FIG. 6 shows a flow diagram of a method for providing another pricing option, performed according to another embodiment of the present invention.

### DETAILED DESCRIPTION

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. Moreover, numerous specific details are set forth below in order to provide a thorough understanding of the present invention. The present invention may be practiced without some or all of these specific details. In other instances, well known process operations have not been described in detail in order not to obscure the present invention.

Embodiments of the present invention provide an online sales mechanism referred to herein as real-time pricing. When practiced by vendors in the context of a sale, real-time pricing can boost the vendor's online sales volume without sacrificing their total profit margin. In addition to benefiting vendors, embodiments of the invention also bring shoppers an interesting and engaging new shopping experience without compromising their expenditures.

According to embodiments of the present invention, a sales event with real-time pricing can be employed for retailing of various items, including commercial goods, services and reservations, and contracts. The sales event provides a plurality of pricing options to customers. In particular, price is presented to the customer as a set or a range of prices with a probability associated with each price. The final sale price is determined using a statistically fair process at checkout. The sales event provides transparency to the statistically fair pricing process by allowing customers to verify information and the results of pricing option requests.

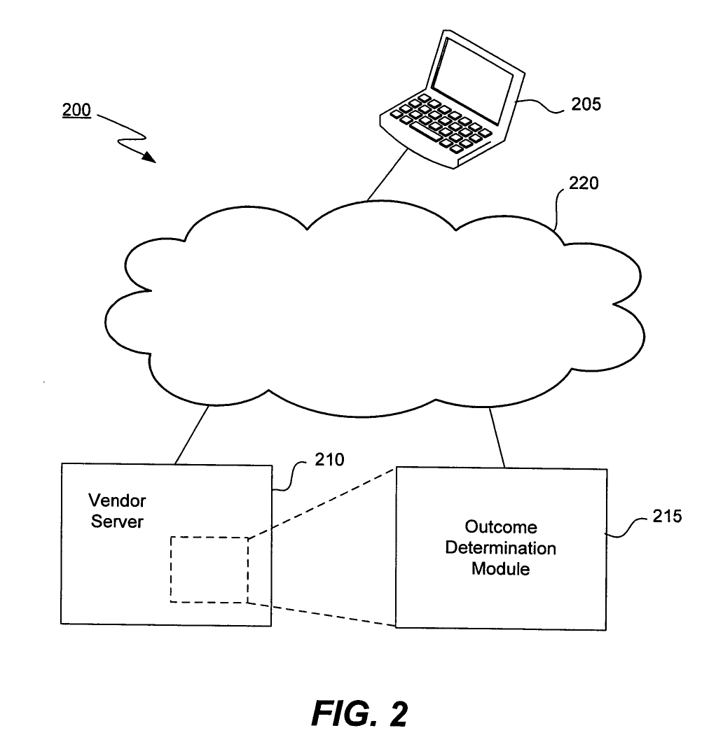

FIG. 2 shows a system 200 for providing a sales event with real-time pricing, constructed according to one embodiment of the present invention. In FIG. 2, the system 200 includes a data processing device 205 capable of being operated by a customer to engage in online shopping. The data processing device 205 is referred to herein as customer device 205. Examples of a suitable data processing device 205 include a personal computer, workstation, or portable data processing device such as a laptop, cell phone, and personal digital assistant (“PDA”).

In FIG. 2, the customer device 205 accesses a shopping website provided on a server 210 operated on behalf of a vendor such as a retailer, over a data network 220 such as the Internet. The server 210 is referred to herein as vender server 210, and the website provided on server 210 is referred to herein as the vendor website. As described herein, the vendor server 210 retrieves pricing options for an online purchase. The vendor server 210 can provide the options to the customer device 205 for display, so the customer can select one of the price options for purchase of selected items.

In FIG. 2, the system 200 further includes an outcome determination module 215, which is coupled to determine a final sale price as an outcome of selection of one of a plurality of pricing options for items to be purchased in the sales event, generally using a statistically fair process. The outcome determination module 215 can be implemented in software and/or hardware on the vendor server 210 or, in an alternative embodiment, on a separate data processing apparatus such as a third party server accessible over data network 220.

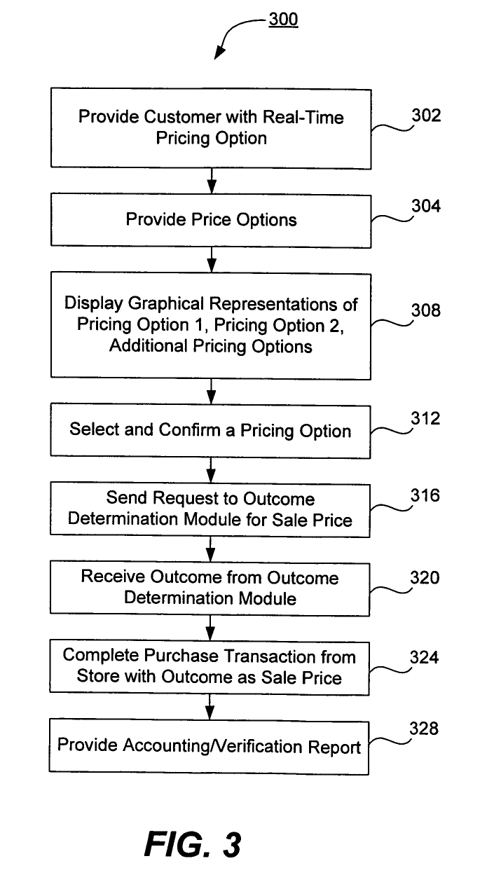

FIG. 3 shows a method 300 for providing pricing options for a sales event over a data network, performed according to one embodiment of the present invention. The method 300 allows multiple pricing options to be presented to customers for an online sale. Customers can review sets of different options, prices/price range, and probabilities associated with the prices, compare the prices with their budget and other stores' sale prices, and in some embodiments, define the prices themselves. Customers can choose a pricing option based on their needs, budgets, and personal preferences.

In FIG. 3, in step 302, during online shopping, the vendor website provides the customer device 205 with the option to participate in a real-time pricing scheme. In one embodiment, the real-time pricing method 300 is applied to individual items selected for purchase. In this embodiment, as items are selected for addition to an electronic shopping cart, the real-time pricing option of step 302 is performed for that particular item. The method can be repeated for additional items selected for purchase. In another embodiment, the method 300 is performed for a plurality of items, for example, when the customer has filled an electronic shopping cart with items for purchase, and initiates a checkout process. In this embodiment, the real-time pricing option of step 302 is provided for part or all of the items in the cart.

In one example, step 302 involves displaying a graphical representation of a button with the label, “Multiple Pricing Checkout Option,” on a graphical user interface displayed on the customer device 205. This step can be performed repeatedly as individual items are selected and added to the cart or, alternatively, after a plurality of various items are selected, and the checkout process begins.

In FIG. 3, in step 302, when the customer selects the real-time pricing option, for instance, by clicking on an appropriate selection on a graphical user interface, the method 300 proceeds to step 304, in which pricing options are provided. On the other hand, if the customer selects a regular checkout option, the item(s) in the customer's shopping cart are sold at a fixed regular price.

In FIG. 3, when the method 300 is performed on an item-by-item basis, the pricing option step 304 involves the customer device 205 sending the vendor server 210 a signal indicating an item selected for purchase. Responsive to receiving this item selection signal, the vendor server 210 retrieves a plurality of pricing options for the selected item. These pricing options can be pre-stored in a storage medium accessible by vendor server 210 or generated and defined for a particular transaction according to customer input, as described herein.

Alternatively, when method 300 is performed for all of the items in the customer's cart, step 304 of FIG. 3 involves the customer device 205 sending a checkout signal over the data network 220 to the vendor server 210, for example by clicking on a “Checkout” button displayed on a graphical interface of customer device 205. The checkout signal indicates the customer's completion of the selection of one or more items for purchase. The costs of the individual items are added to determine a total cost. Responsive to receiving the checkout signal, the vendor server 210 retrieves a plurality of pricing options for the total cost.

In FIG. 3, after the pricing options are retrieved in step 304, the method 300 proceeds to step 308, in which the pricing options are provided to customer device 205 over data network 220. In one embodiment, in step 308, graphical representations of the plurality of pricing options are displayed on a graphical interface of the customer device. When the customer selects one of the displayed pricing options, in step 312, for instance, by clicking on one of the displayed options with a mouse, a pricing option selection signal is sent over data network 220 from customer device 205 to vendor server 210. The pricing option selection signal indicates a selection of one of the displayed pricing options.

In FIG. 3, when the pricing option is selected in step 312, the vendor server 210 sends a request to the pricing outcome determination module 215 in step 316 for a determination of the sale price. Responsive to receiving the request, the outcome determination module 215 determines the sale price, generally according to a statistically fair process using the price and a probability of the selected pricing option. In step 320, the outcome determination module 215 provides the determined sale price to the vendor server 210. The vendor server can provide the determined sale price over the data network 220 to customer device 205, to confirm purchase at the sale price. The customer then sees the determined sale price as the outcome of the selected pricing option, and the sales event is completed in step 324 with purchase of the selected item(s) at the determined sale price.

In FIG. 3, in step 316, a request to the outcome determination module 215 is preferably assigned a unique ID. The unique ID can contain the following information, depending on the desired implementation: vendor name, transaction number, time of the transaction, item number in the purchase, customer ID and other unique information associated with the transaction, the vendor, and the customer. The unique ID can be used to identify the result of a request, and each unique ID is preferably associated with a particular customer record.

In FIG. 3, in step 328, an accounting or verification of the determined sale price can be performed, as requested by the customer device 205 and/or vendor server 210. In one embodiment, the vendor server 210 receives a pricing verification request signal, generated within server 210 or received from customer device 205. The server 210 performs a verification of the plurality of pricing options with a provider of the plurality of pricing options. In some instances, this provider is the vendor. In other instances, the provider of the pricing options is a third party. The result of the verification process is delivered over the data network 220 to the requesting device.

Variations of the method 300 of FIG. 3 that are specific to real-time pricing are contemplated within the spirit and scope of the present invention. In particular, when a customer is the initiator of real-time pricing and the outcome determination module 215 is managing software and/or hardware that determines the final price, there are several possible communication patterns among customer device 205, vendor server 210, and outcome determination module 215. The particular communications pattern can be chosen based on the desired implementation and security level.

In one communications pattern as mentioned above, in step 312 of FIG. 3, customer device 205 sends a request message to the vendor server 210. In step 316, the vendor server 210 sends the request to the outcome determination module 215. After determining the outcome according to a statistically fair process, in step 320, the outcome determination module 215 informs the vendor server 210 of the final sale price. In step 324, the vendor server 210 informs the customer device 205 of the sale price. In one alternative to this communications pattern, in place of step 320, the outcome determination module 215 can directly notify the customer device 205 of the determined final sale price. The customer device 205 can then notify the vendor server 210 of the sale price.

In another alternative communications pattern, in step 316 of FIG. 3, the customer device 205 sends a request message directly to the outcome determination module 215. The outcome determination module 215 determines the final sale price, and informs the vendor server 210 of the final sale price in step 320. The vendor server 210 then informs the customer device 205 of the sale price. In one alternative to this communications pattern, in step 320, rather than communicating through vendor server 210, the outcome determination module 215 can directly notify the customer device 205 of the determined final sale price. The customer device 205 can then notify the vendor server 210 of the sale price.

Generally, the three-way communications among a customer device, a vendor server, and the outcome determination module should be fast, secure, and reliable. These objectives can often be achieved by the above communications patterns using Internet security communication protocols. The goals of the communications patterns are to efficiently process requests, distribute the results for the requests, and prevent fraud.

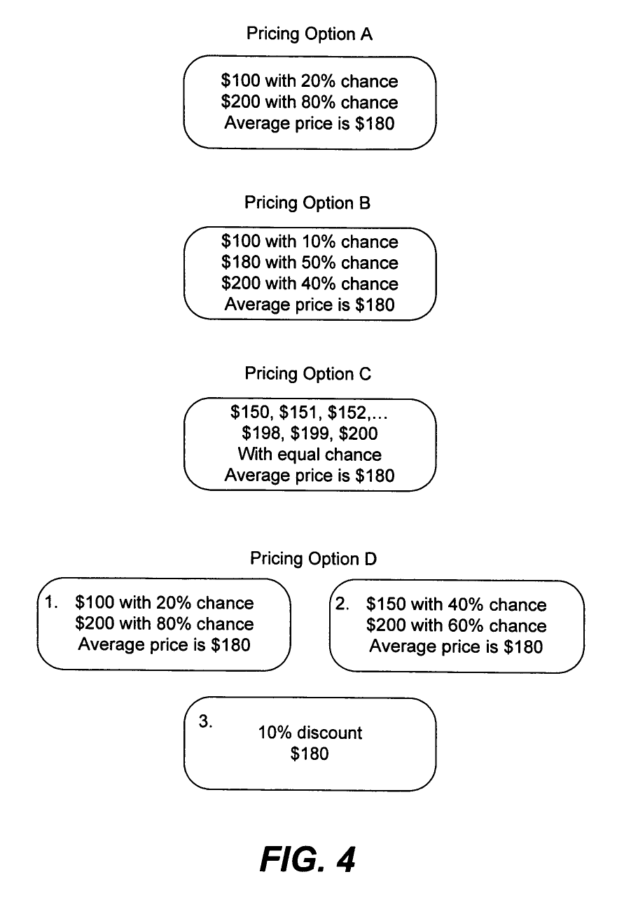

FIG. 4 is a block diagram illustrating a plurality of pricing options provided, for example, in step 308 of FIG. 3, according to embodiments of the present invention. In particular, four examples of real-time pricing options are set forth in FIG. 4. Each pricing option has one or more prices with associated probabilities. The probability of an associated price is the likelihood of receiving that price as the sale price for one or more items. As described above, the actual sale price is determined by outcome determination module 215, coupled as a separate data processing apparatus or as a part of vendor server 210 to determine the price.

In FIG. 4, Pricing Option A includes two preset pricing options, each with a probability of x (0<x<1) and 1−x. For example, an item with a regular price of $200 can be sold for $100 with a probability of 0.2 and $200 with a probability of 0.8. The average price is $180. Pricing Option B sets forth three preset pricing options, each with a probability of x (0<x<1), y (0<y<1, x+y<1) and 1−x−y. The same $200 item can be sold for $100 with a probability of 0.1, $180 with a probability of 0.5, or $200 with a probability of 0.4. The average price is still $180. Pricing Option C includes a price range with preset probability distribution. The same $200 item can be sold from $160 to $200 at $1 increments with equal probability. The average price is still $180.

In FIG. 4, Pricing Option D provides a set of pricing options to customers. Customers execute all of the options in the set and select the best prices among them. For example, as shown in FIG. 4, three sets of options can be executed before a final sale price is determined for an item. Option 1 includes two pricing options, $100 price with an associated probability of 0.2, and $200 with a probability of 0.8. Option 2 includes two pricing options, $150 with a probability of 0.4, and $200 with a probability of 0.6. Option 3 includes a fixed sale price at $180, a 10% discount from the regular price of $200. The final price will be the lowest of the three sets of options. In one example, a customer selects all three of the sets of options. When the pricing option sets are executed, Option 1 gives the customer a price of $200, and Option 2 yields a price of $150. The best sale price is from Option 2 at $150, so this is the final sale price that the customer will pay for the selected item(s).

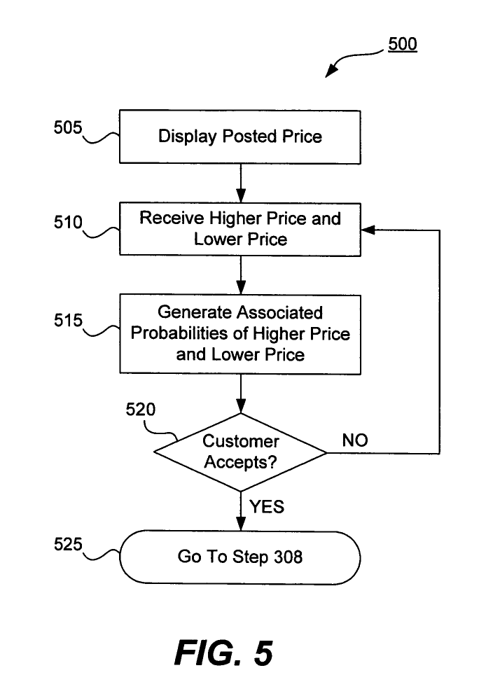

FIG. 5 shows a flow diagram of a method 500 for providing an additional pricing option, according to one embodiment of the present invention. The method 500 provides one possible implementation of step 304 of FIG. 3. The method 500 begins in step 505 by displaying a posted or regular price for a selected item or items. In step 510, customers can enter two prices, one above the posted price and one below. In one implementation, a software module provided as a component of the real-time pricing scheme on vendor server 210 or customer device 205 will generate probabilities for the inputted prices, and notify customers of the probability for each price, in step 515. The software module constructs the probabilities so that the average of the prices is equal to the posted price. Preferably, customers have the opportunity to do multiple rounds of probability checks or evaluate other price options if they do not like the probability results from a given round. Thus, after the display of associated probabilities for the inputted prices, the customer is provided with the option of accepting or rejecting the pricing option in step 520. Rejecting the determined prices and probabilities at step 520 causes the method 500 to return to step 510, while accepting the determined prices and probabilities causes the method 500 to proceed to step 308 of FIG. 3.

In one example of the method of FIG. 5, the posted price for one or more items is $180. When a customer enters $150 and $200 as a lower price and an upper price, respectively, the calculated probability for $150 is 0.4 and for $200 is 0.6. Alternatively, in another round, if the customer enters $100 as the lower price, the calculated probabilities are 0.2 for the $100 price, and 0.8 for the $200 price. In both rounds of pricing, the average price is $180. The customer can select the desired pricing option in step 312 of FIG. 3.

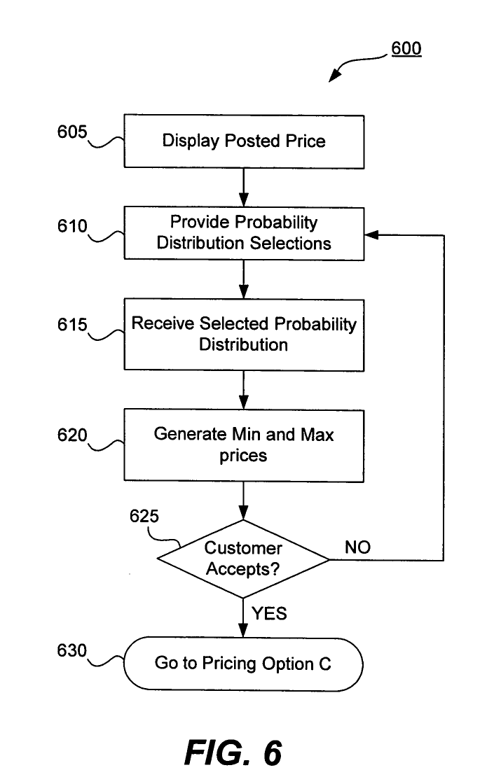

FIG. 6 shows a flow diagram of a method 600 for providing another pricing option, according to one embodiment of the present invention. In step 605, a price is posted. In step 610, customers can select from a list of types of probability distributions and enter a price above or below the posted price. In one implementation, this list of probability distributions is provided in a pull-down menu on a graphical user interface displayed on the customer device 205. In step 615, the customer selects the desired probability distribution. In step 620, a software module implemented on the vendor server 210 and/or the customer device 205 generates and notifies the customer device 205 of maximum and minimum prices, based on the selected probability distribution. In step 625, the customer is provided with the option of accepting the pricing option. When the customer accepts the price range, the option can be executed as Pricing Option C, described with respect to FIG. 4 above. In step 625, when the customer rejects the price range, the customer can select a different distribution, enter a different price, or select a different pricing option. In one example, when the average price is $180, and a customer enters $150 as the low price and selects a uniform probability distribution, the calculated top price is $210 while the lower price is $150.

One pricing option provided according to embodiments of the present invention is a fixed sale price. The fixed price can be any one or a combination of the following: discounted price, rebate, buy one get second one with discount, no shipping fee, no tax, free gifts, and any other incentive such bonus points, no interest for credit card payment, etc.

As mentioned above, real-time pricing options can be applied to individual items or to a collection of items. For instance, real-time pricing options can be provided for the totality of items in a customer's electronic shopping cart on a vendor shopping website. In one implementation, a plurality of pricing options are generated as the last step of checkout, after the total cost of the items in the cart is summed up. Thus, in this implementation, the pricing option is applied to the total sale amount, rather than particular items. For example, when the total cost is $100, the customer can choose from one of the following pricing options:

10% discount

$100 with 10% chance for free

$100 with 20% chance for half price

Other pricing option

In FIG. 2, in one embodiment, customers download a plug-in to a web browser program on customer device 205. The plug-in creates a set of buttons in a toolbar of the web browser. When shopping at an online store using real-time pricing options provided in accordance with embodiments of the present invention, the set of buttons is activated. Examples of functions provided on the buttons are as follows:

1) “Verification:” corresponds to step 328 in FIG. 3; by clicking button, customer can verify real time pricing options are authorized;

2) “Average:” displays the average pricing for a pricing option, for instance, when the mouse moves a pointer over a displayed pricing option on the customer device 205;

3) “Set Prices:” allow online shopper to set prices and associated probabilities within constraints set by the online vendor.

According to embodiments of the present invention, real-time pricing options can be constructed using one or several of the following rules:

1) Provide a set of prices or price range and assign a probability to every price; the sum of the individual probabilities is 1.

2) Let customers input or select one or several of the follow items: price, set of prices, price range and its increment, probability, probability distribution. The input or selected prices and associated probabilities desirably meet a set of constraints provided with the real-time pricing option. The constraints can be one or several of the following: an average price must be met, a low price limit, a top price limit, a probability for a price must be larger or smaller than a probability x (0<x<1), and/or a certain distribution must be selected.

3) Combine a finite number of one or more of the following: any real-time pricing options, a fixed sale price option, and repeat a pricing option one or more times. After all the options are selected and confirmed, customers have the choice of selecting the best price among them.

4) Provide customers with the opportunity to select a statistically fair process from a list of independent providers or a list of different types of statistically fair processes.

5) Apply real-time option to service, support, add-on, and other accessories associated with the product the customer wants to purchase. For example, the real-time pricing option can be applied to give the customer a 0.5 probability for free shipping, and a 0.5 probability for 1 year free warranty.

According to embodiments of the present invention, the real-time pricing scheme involves two parallel procedures. The first procedure is the presentation and explanation of real-time pricing on vendors' websites through additional web-pages or add-on modules. The second procedure is the determination of the final price from various pricing options. Several components facilitate the second procedure: the outcome determination module 215 coupled to perform a statistically fair process, a software module or modules implemented on the customer device 205, vendor server 210 and/or the outcome determination module 215 to interpret real-time pricing rules and determine a final sale price, and three-way communications among a customer through customer device 205, an online vendor at its server 210, and the outcome determination module 215.

In FIGS. 2 and 3, the outcome determination module 215 preferably uses a statistically fair process to assign probabilities to a plurality of prices, to define real-time pricing options in steps 304 and 308. In one implementation, to ensure statistical fairness, the generation of real-time pricing options is linked to a truly random process with known probability. For instance, a random number generator can be used. Numbers generated from a random number generator have equal probability. For instance, a 1 to 100 integer random generator has a probability of 0.2 to output a number between 1 to 20 and a probability of 0.8 to output a number between 21 and 100. Thus, when the number 15 is assigned to a request for real-time pricing options, the request will be in the group of probability of 0.2.

In FIG. 4, for example, using random numbers between 1 and 100 to generate Pricing Option A, the rule to determine the sale price is: if the number assigned by a fair process is not larger than 20, then the item will sell for $100, otherwise, the item will sell for $200. Thus, for example, if the number 35 is assigned to a request, the final sale price is $200.

In FIG. 4, in another example, random numbers between 1 and 100 can be used to generate Pricing Option B. The rule to determine the sale price is: if the number assigned by a fair process is between 1 and 10, the item sells for $100; between 11 and 60, the item sells for $180; between 61 and 100, the item sells for $200. Thus, if the number 35 is assigned to a request, the final sale price is $180.

In FIG. 4, in yet another example, using random numbers between 160 and 200 to generate Pricing Option C, the rule to determine the sale price is: the sale price is the dollar amount of the number assigned to a request by a fair process. If the number 178 is assigned, the final sale price is $178.

For an online store having a data network connection, a real-time interactive pricing process, which is statistically fair, can be initiated with a click of the mouse while online shoppers browse the online store's web page. For example, a pricing option selected by a customer is $20 with an associated probability of 0.75, and free with an associated probability of 0.25. This set of prices and probabilities is equivalent to buying three and getting one for free.

Various graphical user interfaces including graphical representations of pricing options are contemplated within the spirit and scope of the present invention. In one implementation, for an interactive pricing selection process, a ring with four prices disposed about the ring is presented on a customer's display terminal. The four prices are $20, $20, $20, and $0. The customer's first mouse click triggers the ring to spin, and the second click makes it stop. When the ring stops, one of the four prices is shown to the customer as the final sale price.

A software module or modules can interpret the rules of the pricing option and determines the sale price for a particular sales event using a statistically fair process. The software module(s) enforce the rules for the pricing option and publish the final sale price. The software modules can be implemented and located at one or more of the following locations: vendor server 210, customer device 205, and outcome determination module 215, whether implemented on a third party server or on the vendor server 210.

The potential for fraud is contemplated within the spirit and scope of the present invention. Possible frauds that may occur during real-time pricing are as follows:

1) A customer independently alters the determined sale price from the outcome determination module to obtain a better sale price.

2) A store independently alters the determined sale price from the outcome determination module to obtain higher margin.

3) There is collusion between customers and the outcome determination module to provide customers with an unfair price advantage.

4) There is collusion between vendors and the outcome determination module to provide vendors with a high profit margin.

The various communications patterns described above help to prevent such frauds. To ensure the most fairness, the outcome determination module 215, including any statistical processes practiced by the outcome determination module 215, are desirably managed by an independent party. This management provides protection to both customers and stores against frauds. Further protection against frauds is achieved by real-time responses for customers' pricing requests and transparency in the price determining process. The following actions enhance transparency in the statistically fair process:

1) Disclose results for every request to determine a final sale price.

2) Make prior requests, events, or numbers assigned to requests, and final prices, retrievable online.

3) Disclose testing results and routinely monitor results of the statistically fair process.

By using one or more of the communications patterns described above, using IDs for request messages to the outcome determination module, implementing cross-communication to verify price, enhancing transparency in the outcome determination module, and employing an independent fair process, fraud can be minimized and the interests of both customers and stores can be protected.

Preferably, abundant information is provided online to encourage and assist customers to select a real-time pricing option. Depending on the desired implementation, this information can include:

1) Clear explanations of rules and processes used to determine a sale price.

2) An average price determined by real-time pricing.

3) Prior sale prices and prior average sale price by real-time pricing.

4) A number or percentage of customers who selected real-time pricing.

5) The managing party for each step involved in real-time pricing.

6) Reviews from customers and recommendations from stores.

7) A visual demonstration of the process of real-time pricing.

8) Opportunities for real-time interactions between the customers and the outcome determination module.

The real-time pricing schemes described herein are not limited to the sale of goods. The various techniques can be applied to the sales of services and contracts. For example, real-time pricing can be used for the sales of travel tickets, hotel rooms, and event tickets. Embodiments of the present invention can even be applied to online auctions.

In addition, using aspects of the methods and apparatus described herein, real-time pricing can be implemented by traditional brick and mortal stores for goods, services and contracts, and other monetary transactions. For example, real-time pricing can be executed during checkout with assistance from a cashier or at a self-checkout station. The sales event can be an occasional event or continuous event. The sales event can apply to a few items or a store/department wide sale.

As described above, real-time pricing during a sales event is a novel tool for the retail sale of commercial goods, services, and contracts, with real-time pricing options. Both customers and stores benefit from real-time pricing. The customers will have an opportunity to buy a product at a significantly lower price, or for free in some pricing options, without having to wait for a significant sales event. The stores will boost sales volume by attracting more customers while maintaining their total profit margin.

In one alternative embodiment, the real-time pricing schemes described herein are applied to a marketplace where multiple vendors sell their various items. Thus, embodiments of the methods and apparatus described above apply to all of the vendors, by virtue of their participation in the marketplace.

In another alternative embodiment, one vendor provides an access point to another vendor through a pricing option. For example, an item is offered for sale at a $20 regular price in an online store. The following pricing options are generated:

Option 1: $20 with 10% chance for free (same as $10 cash back)

Option 2: $20 with 20% chance for $15 (same as $5 cash back)

Option 3: $19. Please visit store B, a separate online or physical vendor

In the pricing options above, Option 3 is essentially an advertisement for store B. In some implementations, a graphical display of Option 3 provides a hyperlink to store B's website. Thus, a single store or website can be an advertising host for multiple stores and products. Option 1 and Option 2 can be managed by the vendor server or a third party. This embodiment can simplify the implementation of real-time pricing options.

Embodiments of the invention, including the methods, apparatus, modules, servers, and devices described herein, can be implemented in digital electronic circuitry, or in computer hardware, firmware, software, or in combinations of them. Apparatus embodiments of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. Embodiments of the invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and Flash memory devices; magnetic disks such as internal hard disks and removable disks; magneto-optical disks; and CD-ROM disks. Any of the foregoing can be supplemented by, or incorporated in, ASICs (application-specific integrated circuits).

While the invention has been particularly shown and described with reference to specific embodiments thereof, it will be understood by those skilled in the art that changes in the form and details of the disclosed embodiments may be made without departing from the spirit or scope of the invention. For instance, in another embodiment, a credit card or other suitable purchase/identification mechanism gives the customer a membership in a program enabling the real-time pricing option for the player. Thus, using the credit card to make a purchase, the customer gets a discount to individual items or a collection of items with pricing options at the checkout point. Thus, the examples described herein are not intended to be limiting of the present invention. It is therefore intended that the appended claims will be interpreted to include all variations, equivalents, changes and modifications that fall within the true spirit and scope of the present invention.

1. A method for providing pricing options for a sales event of online shopping over a data network, the method comprising:
receiving an item selection signal over the data network from a data processing device associated with a customer, the item selection signal indicating an item selected for purchase;
responsive to receiving the item selection signal, retrieving a plurality of pricing options for the selected item;
generating a graphical representation of the plurality of pricing options for display on the data processing device associated with the customer;
receiving a pricing option selection signal over the data network from the data processing device associated with the customer, the pricing option selection signal indicating a selected one of the plurality of pricing options;
retrieving a pricing outcome from an outcome determination module, the pricing outcome determining a sale price according to a price and a probability of the selected one pricing option; and
providing the sale price over the data network to the data processing device associated with the customer for purchase of the selected item.

2. The method of claim 1, further comprising:
receiving a pricing verification request signal from the data processing device;
performing a verification of the plurality of pricing options with a provider of the plurality of pricing options;
receiving a result of the performed verification; and
providing the result of the performed verification over the data network to the data processing device associated with the customer.

3. The method of claim 1, wherein one of the plurality of pricing options includes a reference to a vendor.

4. The method of claim 1, wherein the item is one of the group consisting of a good, a service, a reservation, and a contract.

5. The method of claim 1, wherein the outcome determination module is coupled to apply a statistical process to determine the pricing outcome according to the price and the probability of the selected one pricing option.

6. The method of claim 5, wherein the statistical process is a fair process.

7. The method of claim 1, wherein the price of the selected one pricing option is determined by the customer.

8. The method of claim 1, wherein the probability of the selected one pricing option is determined by the customer.

9. A method for providing pricing options for a sales event of online shopping over a data network, the method comprising:
receiving a checkout signal over the data network from a data processing device associated with a customer, the checkout signal indicating completion of selection of one or more items for purchase, the one or more items having a total cost;
responsive to receiving the checkout signal, retrieving a plurality of pricing options for the total cost;
generating a graphical representation of the plurality of pricing options for display on the data processing device associated with the customer;
receiving a pricing option selection signal over the data network from the data processing device associated with the customer, the pricing option selection signal indicating a selected one of the plurality of pricing options;
retrieving a pricing outcome from an outcome determination module, the pricing outcome determining a sale price according to a price and a probability of the selected one pricing option; and
providing the sale price over the data network to the data processing device associated with the customer for purchase of the selected one or more items.

10. The method of claim 9, further comprising:
receiving a customer ID associated with the customer;
determining that the received customer ID enables a discount;
applying the discount to the plurality of pricing options.

11. The method of claim 9, further comprising:
receiving a pricing verification request signal from the data processing device;
performing a verification of the plurality of pricing options with a provider of the plurality of pricing options;
receiving a result of the performed verification; and
providing the result of the performed verification over the data network to the data processing device associated with the customer.

12. The method of claim 9, wherein one of the plurality of pricing options includes a reference to a vendor.

13. The method of claim 9, wherein the item is one of the group consisting of a good, a service, a reservation, and a contract.

14. The method of claim 9, wherein the outcome determination module is coupled to apply a statistically fair process to determine the pricing outcome according to the price and the probability of the selected one pricing option.

15. The method of claim 9, wherein the price of the selected one pricing option is determined by the customer.

16. The method of claim 9, wherein the probability of the selected one pricing option is determined by the customer.

17. A data processing apparatus for providing pricing options for a sales event of online shopping over a data network, the data processing apparatus comprising:
an interface in communication with the data network, the interface coupled to receive a checkout signal over the data network from a data processing device associated with a customer, the checkout signal indicating completion of selection of one or more items for purchase, the one or more items having a total cost;
a memory storing instructions; and
a processor in communication with the interface and the memory, the processor operable to receive the checkout signal from the interface, load the instructions from the memory responsive to receiving the checkout signal, and execute the instructions to:
a) retrieve a plurality of pricing options for the total cost,
b) generate a graphical representation of the plurality of pricing options for display on the data processing device associated with the customer,
c) receive a pricing option selection signal, the pricing option selection signal indicating a selected one of the plurality of pricing options,
d) retrieve a pricing outcome from an outcome determination module, the pricing outcome determining a sale price according to a price and a probability of the selected one pricing option, and
e) output the sale price.

18. A computer program product, stored on a processor readable medium, comprising instructions operable to cause a data processing apparatus to perform a method for providing pricing options for a sales event of online shopping over a data network, the method comprising:
receiving a checkout signal over the data network from a data processing device associated with a customer, the checkout signal indicating completion of selection of one or more items for purchase, the one or more items having a total cost;
responsive to receiving the checkout signal, retrieving a plurality of pricing options for the total cost;
generating a graphical representation of the plurality of pricing options for display on the data processing device associated with the customer;
receiving a pricing option selection signal over the data network from the data processing device associated with the customer, the pricing option selection signal indicating a selected one of the plurality of pricing options;
retrieving a pricing outcome from an outcome determination module, the pricing outcome determining a sale price according to a price and a probability of the selected one pricing option; and
providing the sale price over the data network to the data processing device associated with the customer for purchase of the selected one or more items.

19. A method for providing pricing options for a sales event of online shopping over a data network, the method comprising:
receiving an item selection signal over the data network from a data processing device associated with a customer, the item selection signal indicating an item selected for purchase;
responsive to receiving the item selection signal, retrieving a plurality of pricing options for the selected item;
generating graphical representations of the plurality of pricing options for display on the data processing device associated with the customer;
receiving a first pricing option selection signal over the data network from the data processing device associated with the customer, the first pricing option selection signal indicating a first one of the plurality of pricing options;
receiving a second pricing option selection signal over the data network from the data processing device associated with the customer, the second pricing option selection signal indicating a second one of the plurality of pricing options;
retrieving a first pricing outcome from an outcome determination module, the first pricing outcome determining a first sale price according to the first pricing option; and
retrieving a second pricing outcome from the outcome determination module, the second pricing outcome determining a second sale price according to the second pricing option; and
determining a lower one of the first sale price and the second sale price;
providing the lower one of the first and second sale prices over the data network to the data processing device associated with the customer for purchase of the selected item.

20. The method of claim 19, wherein the first pricing option includes a plurality of prices with associated probabilities having an average price.

21. The method of claim 19, wherein the first pricing option includes a fixed price.
